(19) United States
(12) Patent Application Publication
(10) Pub. No.: US 2007/0057565 A1
(43) Pub. Date: Mar. 15, 2007

(54) Coaxial structure for a wheel set

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/223,999

(22) Filed: Sep. 13, 2005

(51) Int. Cl. B60B 25/00

(52) U.S. Cl. 301/13.1

(57) ABSTRACT

A coaxial structure for a wheel set includes a main wheel, a pair of side wheels and a wheel frame. The side wheels are coupled to respective sides of the main wheel. The main wheel and the side wheels comprise through holes at the center. Each side wheel comprises a recess at one side with a washer seating in the recess. The wheel frame has an axle to insert through the through holes of the side wheels and the main wheel as well as the washers.

### BACKGROUND OF THE INVENTION

1. Field of the Invention

The present invention relates to a coaxial structure for a wheel set, and more particularly to one applied to a tricycle or a training cart.

2. Description of the Prior Art

Playing carts includes tricycles and training carts. The design of rear wheels has been changed from round shape to egg-shaped (or Football) wheel.

This egg-shaped wheel is made in the form of one-piece, which has a high manufacturing cost and a higher unqualified rate, in particular the size of the wheel is fixed, which can not be replaced with other specifications.

### SUMMARY OF THE INVENTION

It is the primary object of the present invention to provide a coaxial structure for a wheel set, which is easy to mount and dismount.

It is another object of the present invention to provide a coaxial structure for a wheel set, which is easy to do quality control during manufacture.

It is a further object of the present invention to provide a coaxial structure for a wheel set, which can choose any main wheel or side wheel in different size.

The present invention includes a main wheel, a pair of side wheels and a wheel frame. The side wheels are coupled to respective sides of the main wheel. The main wheel and the side wheels comprise through holes at the center. Each side wheel comprises a recess at one side with a washer seating in the recess. The wheel frame has an axle to insert through the through holes of the side wheels and the main wheel as well as the washers.

### BRIEF DESCRIPTION OF THE DRAWINGS

FIG. 1 is a perspective view of a first embodiment of the present invention applied to a tricycle;

FIG. 2 is a rear view of the first embodiment of the present invention, and

FIG. 3 is a rear view of a second embodiment of the present invention.

### DETAILED DESCRIPTION OF THE PREFERRED EMBODIMENTS

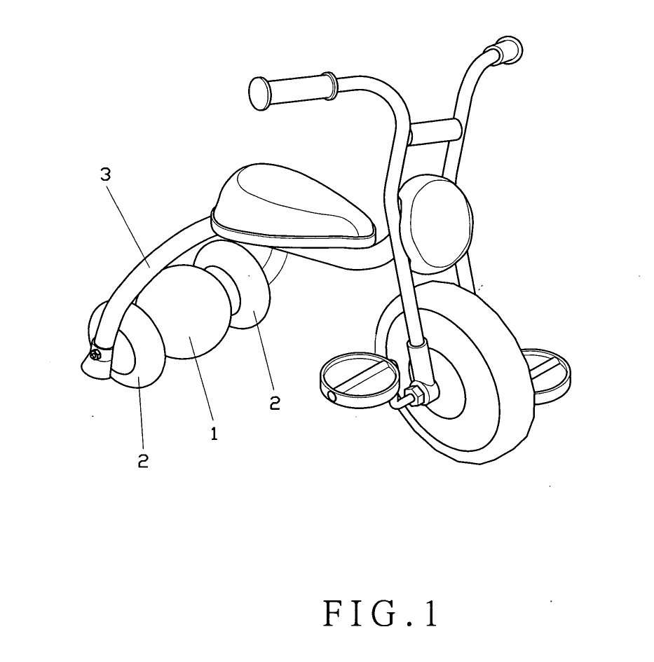

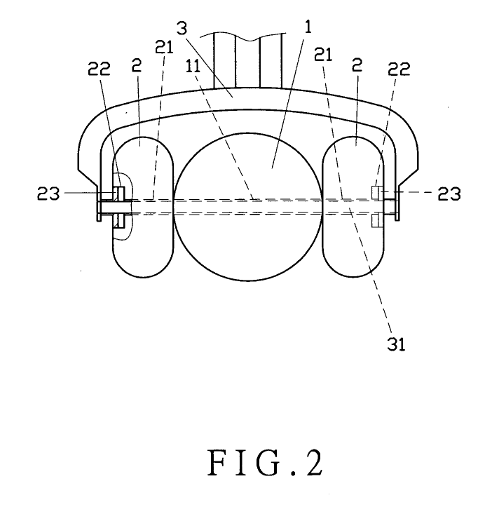

The present invention, as shown in FIGS. 1 and 2, comprises a main wheel 1, two side wheels 2 and a wheel frame 3.

The two side wheels 2 are coupled to respective sides of the main wheel 1. The main wheel 1 and the side wheels 2 are formed with through holes 11 and 21 at the center thereof. One side of each side wheel 2 has a recess 22 to receive a washer 23 therein. The wheel frame 3 has an axle 31 to insert through the through holes 11 and 21 of the main wheel 1 and the side wheels 2 as well as the washers 23.

In practice, as shown in FIG. 1, the present invention is applied to a tricycle. The main wheel 1 and the side wheels 2 are coaxially connected to the wheel frame 3. Accordingly, the user may choose any main wheel 1 or side wheel 2 in different size, and it is easy to mount or to dismount the wheels.

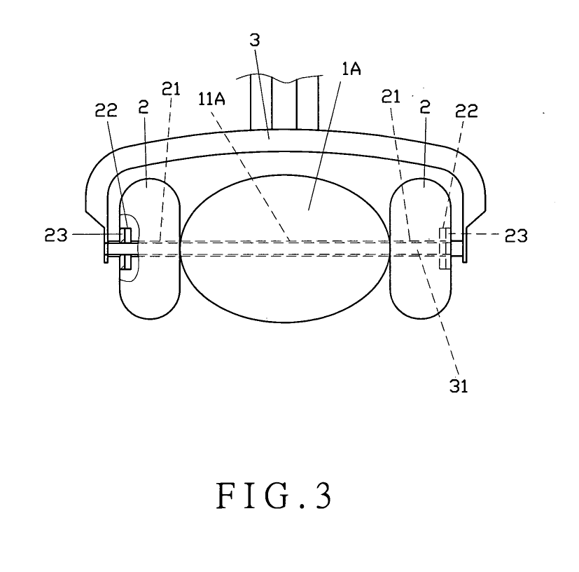

FIG. 3 shows another embodiment of the present invention, which includes a main wheel 1A, a pair of side wheels 2 and a wheel frame 3. The main wheel 1A has an egg-shaped contour with a through hole 11A at the center, while the side wheels 2 and the wheel frame 3 are identical to the ones as described in FIGS. 1 and 2.

I claim:

1. A coaxial structure for a wheel set comprising a main wheel, two side wheels and a wheel frame, said side wheels being coupled to respective sides of said main wheel, said main wheel and said side wheels comprising through holes at the center, said wheel frame having an axle to insert through said through holes of said main wheel and said side wheels, said axle being pivotally connected to said wheel frame.
